(19) United States
(12) Patent Application Publication
(10) Pub. No.: US 2024/0429644 A1
(43) Pub. Date: Dec. 26, 2024

(54) CONNECTOR AND CONNECTOR CONNECTION STRUCTURE

(71) Applicants: FURUKAWA ELECTRIC CO., LTD., Tokyo (JP); FURUKAWA AUTOMOTIVE SYSTEMS INC., Inukami-gun (JP)

(72) Inventors: Tomoaki TANIGAWA, Inukami-gun (JP); Takayuki HIGUCHI, Inukami-gun (JP); Takeshi WATANABE, Inukami-gun (JP)

(73) Assignees: FURUKAWA ELECTRIC CO., LTD., Tokyo (JP); FURUKAWA AUTOMOTIVE SYSTEMS INC., Inukami-gun (JP)

(21) Appl. No.: 18/823,793

(22) Filed: Sep. 4, 2024

Related U.S. Application Data
(63) Continuation of application No. PCT/JP2023/007074, filed on Feb. 27, 2023.

(30) Foreign Application Priority Data
Mar. 18, 2022 (JP) 2022-044463

(51) Int. Cl. H01R 13/502; H01R 13/52; H01R 13/621

(52) U.S. Cl. CPC H01R 13/502; H01R 13/5202; H01R 13/5205; H01R 13/6215; H01R 2201/10; H01R 2201/26

(57) ABSTRACT

The object is to provide a connector and a connector connection structure that, even if an electric wire is vibrated, may suppress influence of the vibration.

A housing 22, 23 includes an insertion cylinder 221, 231 in communication with a main body 222, 232 and having a high-voltage electric wire 201 inserted thereinto. An electric wire retaining portion 28 provided on the harness insertion outer cylinder 231 and retaining the high-voltage electric wire 201 has an electric wire insertion hole 281 retaining the high-voltage electric wire 201 inserted thereinto, and further includes a securing-side retaining portion 282 provided on the harness insertion outer cylinder 231 and having securing-side arcked grooves 281a, and an attachment retaining portion 283 having attachment-side arcked grooves 281b and attached to the securing-side retaining portion 282.

### TECHNICAL FIELD

The present invention relates to a connector and a connector connection structure to be attached to, for example, a wire harness or the like and to be connected to a device such as a motor or the like.

### BACKGROUND ART

An electric device mounted on an automobile or the like is connected with another electric device or a power supply device via a wire harness including a bundle of covered electric wires and thus forms an electric circuit. The wire harness and the electric device or the power supply device are connected with each other via connectors attached thereto.

For example, a harness-side connector described in Patent Literature 1 is connected with a device-side connector included in a device such as a motor or the like.

Specifically, a terminal provided in the harness-side connector and a terminal provided in the device-side connector are connected with each other to connect the harness-side connector and the device-side connector to each other in an electrically conductive manner.

In the case where the voltage for the electric conduction in such a connector connection structure is increased and as a result, an electric wire having a large diameter is used, such an electric wire to be inserted into a connector housing needs to be more rigid. When such a rigid electric wire is vibrated, the vibration may undesirably affect the connector.

### CITATION LIST

### Patent Literature

Patent Literature 1: JP 2012-109035 A

### SUMMARY OF INVENTION

### Technical Problem

The present invention has an object of providing a connector and a connector connection structure that, even if an electric wire is vibrated, may suppress influence of the vibration thereon.

### Solution to Problem

The present invention is directed to a connector, including an electric wire having a harness-side terminal attached to a tip thereof; and a housing having the harness-side terminal disposed therein. The housing includes a housing main body having the harness-side terminal disposed therein, and an electric wire insertion portion in communication with the housing main body, the electric wire insertion portion having the electric wire inserted thereinto. The electric wire insertion portion has an electric wire retaining portion provided thereon, the electric wire retaining portion retaining the electric wire. The electric wire retaining portion has an electric wire insertion hole retaining the electric wire inserted thereinto. The electric wire retaining portion further includes a securing-side retaining portion provided on the housing main body and defining a part of the electric wire insertion hole, and an attachment retaining portion defining another part of the electric wire insertion hole, the attachment retaining portion being attached to the securing-side retaining portion.

The electric wire insertion portion may have a cross-section that is elliptical, circular or polygonal, or may have any appropriate cross-sectional shape such that the electric wires may be inserted thereinto.

The electric wire insertion hole has a cross-sectional shape that is along an outer circumferential surface of the electric wire, and the cross-section may be circular, elliptical or polygonal. The electric wire insertion hole may be along the entirety of the outer circumferential surface of the electric wire, or a part thereof in the circumferential direction may be opened.

According to the invention, even if the electric wire is vibrated, the influence of the vibration is suppressed.

This will be described in more detail. The electric wire retaining portion having the electric wire insertion hole retaining the electric wire is provided on the electric wire insertion portion. The electric wire insertion portion is included in the housing. The housing includes the electric wire insertion portion and the housing main body having the harness-side terminal disposed therein. The electric wire insertion portion is in communication with the housing main body, and has the electric wire inserted thereinto. The electric wire retaining portion includes the securing-side retaining portion and the attachment retaining portion. The securing-side retaining portion is provided on the housing main body and defines a part of the electric wire insertion hole. The attachment retaining portion defines another part of the electric wire insertion hole, and is attached to the securing-side retaining portion.

Therefore, the attachment retaining portion is attached to the securing-side retaining portion provided on the housing main body, and thus the electric wire retaining portion having the electric wire insertion hole is formed. The electric wire is retained by the electric wire retaining portion. That is, the attachment retaining portion is attached to the securing-side retaining portion provided on the housing main body, and thus the housing is formed and also the electric wire retaining portion is formed to retain the electric wire. Therefore, even if the electric wire is vibrated, the exertion of the influence of the vibration on the housing is suppressed.

In an embodiment of the present invention, the connector may further include a pressing portion provided on at least a part of an inner surface defining the electric wire insertion hole, the pressing portion locally pressing at least a part of a portion, of an outer surface of the electric wire, that is inserted into the electric wire insertion hole.

The aforementioned “at least a part of a portion, of an outer surface of the electric wire, that is inserted into the electric wire insertion hole” is a part of, or the entirety of, the outer surface of the portion, of the electric wire, inserted into the electric wire insertion hole.

The aforementioned “inner surface defining the electric wire insertion hole” is at least one of: the inner surface defining a part of the electric wire insertion hole in the securing-side retaining portion, and the inner surface defining another part of the electric wire insertion hole in the attachment retaining portion.

The “pressing portion” may be, for example, a protrusion or a concaved and convexed portion formed at the inner surface of the electric wire insertion portion, and may have any shape that increases a local pressure applied to the outer surface of the electric wire.

The pressing portion may be a pressing portion formed in the circumferential direction of the electric wire, a pressing portion formed in a longitudinal direction of the electric wire, or a pressing portion including a plurality of scattered pieces. One pressing portion, or a plurality of pressing portions, may be provided in the electric wire insertion hole.

According to the invention, the attachment retaining portion is attached to the securing-side retaining portion, and thus the pressing portion locally press at least a part of the outer surface of a portion, of the electric wire, that is inserted into the electric wire insertion hole. Therefore, the securing force of the electric wire on the electric wire insertion holes is increased, and thus the electric wire is retained with certainty.

In an embodiment of the present invention, the electric wire insertion hole may have a circular shape having a diameter substantially the same as that of the electric wire. The pressing portion may have a rib shape that extends in a circumferential direction on an inner circumferential surface defining the electric wire insertion hole and protrudes toward a center of the electric wire insertion hole.

According to the invention, the outer surface of the electric wire inserted into the electric wire insertion hole is pressed by the rib-shaped pressing portion extending in the circumferential direction and protruding toward the center of the electric wire insertion hole. The pressing portion pressing the outer surface extends in the circumferential direction. Therefore, even if an external force acts on the electric wire in a direction in which the electric wire is pulled out, the pressing force of the pressing portion acts against the external force in such a pulling direction efficiently.

The pressing portion has a rib shape extending in the circumferential direction and also protruding toward the center of the electric wire insertion hole. Therefore, moisture flowing on the outer surface of the electric wire is prevented from entering the inside of the connector from the electric wire insertion hole.

In an embodiment of the present invention, a plurality of the pressing portions each having the rib shape may be provided at a predetermined interval in a direction in which the electric wire insertion hole extends.

According to the invention, the plurality of rib-shaped pressing portions, provided at a predetermined interval in a direction in which the electric wire insertion hole extends, press the outer surface of the electric wire. Therefore, the force of the pressing portions against the external force acting on the electric wire in the pulling direction is increased. The plurality of rib-shaped pressing portions are provided at the predetermined interval in the direction in which the electric wire insertion hole extends, and therefore, the capability of the rib-shaped pressing portion of stopping the moisture flowing on the outer surface of the electric wire is improved.

In an embodiment of the present invention, the attachment retaining portion and the securing-side retaining portion may be formed separately from each other. The connector may include a securing portion assembling and securing the attachment retaining portion and the securing-side retaining portion to each other.

According to the invention, the electric wire is easily disposed in the electric wire insertion hole provided in the securing-side retaining portion. The attachment retaining portion is attached and secured to the securing-side retaining portion, separately formed therefrom and having the electric wire disposed therein, by the securing portion. Thus, the electric wire inserted into the electric wire insertion hole is retained easily and certainly.

In an embodiment of the present invention, the securing portion may be a tightening member tightening and securing the attachment retaining portion and the securing-side retaining portion to each other.

The tightening member includes a bolt and a nut (tightening hole) tightening and securing the attachment retaining portion and the securing-side retaining portion assembled together. The tightening member may include a bolt and a nut formed separately from the attachment retaining portion and the securing-side retaining portion. Alternatively, a nut or a tightening hole provided at one of the attachment retaining portion and the securing-side retaining portion may be tightened by a bolt provided on the other of the attachment retaining portion and the securing-side retaining portion. Still alternatively, a bolt provided on one of the attachment retaining portion and the securing-side retaining portion may be inserted into the other of the attachment retaining portion and the securing-side retaining portion to tighten a nut separately formed.

According to the invention, the attachment retaining portion and the securing-side retaining portion assembled together are tightened by the tightening member, and thus the tightening force acts to secure the attachment retaining portion and the securing-side retaining portion with certainty.

The attachment retaining portion and the securing-side retaining portion assembled together are secured by the tightening member. Therefore, the attachment retaining portion and the securing-side retaining portion are secured in a predetermined securing state by adjusting the tightening force of the tightening member.

In an embodiment of the present invention, the connector may further include an electric wire seal outserted over a portion of the electric wire that is inserted into the electric wire insertion portion and sealing a space between the electric wire insertion portion and the electric wire on the side of the housing main body with respect to the electric wire retaining portion.

According to the invention, the space between the electric wire insertion portion and the electric wire is sealed on the side of the housing main body with respect to the electric wire retaining portion. In addition, the electric wire seal is disposed on the side of the housing main body with respect to the electric wire retaining portion. Therefore, the electric wire seal is prevented by the electric wire retaining portion from being pulled off inadvertently.

The electric wire seal may be pressed by the electric wire retaining portion, such that a pre-stress may act to improve the sealability of the electric wire seal. Alternatively, the electric wire seal and the electric wire retaining portion may merely contact each other, or may be provided at an interval. In this manner, the electric wire seal is prevented from being pulled off inadvertently.

In an embodiment of the present invention, a plurality of the electric wires may be provided, and a plurality of the electric wire insertion holes may be provided in accordance with the number of the electric wires.

According to the invention, the plurality of electric wires are inserted into the electric wire insertion holes respectively, and are secured with certainty. The electric wire insertion holes, provided in accordance with the number of the electric wires, may be coupled with each other.

In an embodiment of the present invention, the housing main body may include a counterpart securing portion securing the housing to a counterpart connector having a counterpart terminal connected with the harness-side terminal.

According to the invention, the connector and the counterpart connector are connected with each other firmly. Therefore, the connector-side terminal disposed in the housing and the counterpart terminal disposed in the counterpart connector are connected with each other in a stable connection state.

It is now assumed that the housing main body is formed of a metal material and a part of the housing or the like of the counterpart connecter is formed of a metal material. In the case where the housing is secured to the metal portion of the counterpart connector by the counterpart securing portion, the metal housing main body and the metal portion of the counterpart connector are electrically conductively connected with each other.

In an embodiment of the present invention, the housing may include an outer shell and an inner housing disposed in the outer shell. The outer shell may include an outer shell main body corresponding to the housing main body and an outer electric wire insertion portion corresponding to the electric wire insertion portion. The inner housing may include an inner housing main body corresponding to the housing main body and an inner electric wire insertion portion corresponding to the electric wire insertion portion.

According to the invention, the housing main body is disposed in the outer shell main body, and the inner electric wire insertion portion is disposed in the outer electric wire insertion portion. The electric wire is inserted from the inner electric wire insertion portion, and the harness-side terminal provided at the tip of the electric wire is disposed in the inner housing main body.

In an embodiment of the present invention, in a state where the inner housing main body is connected with the counterpart connector including the counterpart terminal connected with the harness-side terminal, the inner housing main body may be fitted with a counterpart housing of the counterpart connector, and a housing seal may be disposed between the inner housing main body and the counterpart housing fitted with the inner housing main body.

According to the invention, the inner housing main body and the counterpart housing are connected with each other in a stable connection state with no rattling. In the state where the inner housing main body is fitted with the counterpart housing of the counterpart connector, the housing seal is disposed between the inner housing main body and the counterpart housing fitted with the inner housing main body. Therefore, the portion where the counterpart housing and the inner housing main body are filled to each other is protected against entrance of moisture.

In an embodiment of the present invention, the outer shell may include the electric wire retaining portion. The inner electric wire insertion portion may be disposed in the outer electric wire insertion portion on the side of the housing main body with respect to the electric wire retaining portion.

According to the invention, the inner electric wire insertion portion is disposed in the outer electric wire insertion portion, on the side of the housing main body with respect to the electric wire retaining portion. Therefore, the electric wire is retained with certainty by the electric wire retaining portion. In addition, the influence of the vibration on the inner housing is suppressed. The electric wire retaining portion is formed by assembling the attachment retaining portion and the securing-side retaining portion with each other in the outer shell.

In an embodiment of the present invention, the electric wire insertion portion may be cylindrical. The attachment retaining portion may be provided on a part of the outer electric wire insertion portion. The attachment retaining portion and the securing-side retaining portion may be secured to each other by the securing portion to form the electric wire insertion portion to be cylindrical.

According to the invention, the attachment retaining portion provided on a part of the outer electric wire insertion portion is assembled with the securing-side retaining portion, and thus the cylindrical electric wire insertion portion is formed.

In an embodiment of the present invention, at least a part of the inner electric wire insertion portion may be disposed in the outer electric wire insertion portion provided on the attachment retaining portion.

According to the invention, the attachment retaining portion provided on a part of the outer electric wire insertion portion is assembled with the securing-side retaining portion, and thus the inner electric wire insertion portion is secured in the outer electric wire insertion portion.

In an embodiment of the present invention, the outer shell may be formed of a metal material.

According to this, the housing including the metal outer shell has a shielding double structure.

In an embodiment of the present invention, a resin retainer having the electric wire insertion hole may be provided between the electric wire retaining portion in the metal outer shell and the electric wire.

According to the invention, the electric wire retaining portion, in the metal outer shell, that is formed by assembling the secured-side retaining portion and the attachment retaining portion to each other retains the electric wire via the resin retainer.

In an embodiment of the present invention, the connector may further include an electric wire insertion portion seal sealing a space between the inner electric wire insertion portion and the outer electric wire insertion portion.

According to the invention, the space between the inner electric wire insertion portion and the outer electric wire insertion portion is sealed. Therefore, foreign objects are prevented from entering the connector through a space between the inner electric wire insertion portion and the outer electric wire insertion portion.

The present invention is directed to a connector connection structure including a connector including an electric wire having a harness-side terminal attached to a tip thereof and also including a housing including the harness-side terminal disposed therein, and a counterpart connector including a counterpart terminal connected with the harness-side terminal. The connector and the counterpart connector are connected with each other. The housing includes a housing main body having the harness-side terminal disposed therein, and an electric wire insertion portion in communication with the housing main body, the electric wire insertion portion having the electric wire inserted thereinto. The electric wire insertion portion has an electric wire retaining portion provided thereon, the electric wire retaining portion retaining the electric wire. The electric wire retaining portion has an electric wire insertion hole retaining the electric wire inserted thereinto. The electric wire retaining portion further includes a securing-side retaining portion provided on the housing main body and defining a part of an electric wire insertion hole, and an attachment retaining portion defining another part of the electric wire insertion hole, the attachment retaining portion being attached to the securing-side retaining portion.

According to the invention, even if the electric wire is vibrated, the influence of the vibration is suppressed.

This will be described in more detail. The electric wire retaining portion having the electric wire insertion hole retaining the electric wire is provided on the electric wire insertion portion. The electric wire insertion portion is included in the housing. The housing includes the electric wire insertion portion and the housing main body having the harness-side terminal disposed therein. The electric wire insertion portion is in communication with the housing main body, and has the electric wire inserted thereinto. The electric wire retaining portion includes the securing-side retaining portion and the attachment retaining portion. The securing-side retaining portion is provided on the housing main body and defines a part of the electric wire insertion hole. The attachment retaining portion defines another part of the electric wire insertion hole, and is attached to the securing-side retaining portion.

Therefore, the attachment retaining portion is attached to the securing-side retaining portion provided on the housing main body, and thus the electric wire retaining portion having the electric wire insertion hole is formed. The electric wire is retained by the electric wire retaining portion. That is, the attachment retaining portion is attached to the securing-side retaining portion provided on the housing main body, and thus the housing is formed and also the electric wire retaining portion is formed to retain the electric wire. Therefore, even if the electric wire is vibrated, the exertion of the influence of the vibration on the housing is suppressed.

In an embodiment of the present invention, the housing main body may include a counterpart securing portion securing the housing to the counterpart connector.

According to the invention, the connector and the counterpart connector are connected with each other firmly in the connector connection structure. Therefore, the connector-side terminal disposed in the housing and the counterpart terminal disposed in the counterpart connector are connected with each other in a stable connection state.

It is now assumed that the housing main body is formed of a metal material and a part of the housing or the like of the counterpart connecter is formed of a metal material. In the case where the housing is secured to the metal portion of the counterpart connector by the counterpart securing portion, the metal housing main body and the metal portion of the counterpart connector are electrically conductively connected with each other.

In an embodiment of the present invention, the housing may include an outer shell and an inner housing disposed in the outer shell. The outer shell may include an outer shell main body corresponding to the housing main body and an outer electric wire insertion portion corresponding to the electric wire insertion portion. The inner housing may include an inner housing main body corresponding to the housing main body and an inner electric wire insertion portion corresponding to the electric wire insertion portion. The inner housing main body may be fitted with a counterpart housing of the counterpart connector. A housing seal may be disposed between the inner housing main body and the counterpart housing fitted with the inner housing main body.

According to the invention, the housing main body is disposed in the outer shell main body, and the inner electric wire insertion portion is disposed in the outer electric wire insertion portion. The electric wire is inserted from the inner electric wire insertion portion, and the harness-side terminal provided at the tip of the electric wire is disposed in the inner housing main body.

In the connector connection structure, the housing main body is fitted with the counterpart housing of the counterpart connector. The housing seal is disposed between the housing main body and the counterpart housing fitted with the housing main body. Therefore, the inner housing main body and the counterpart housing are connected in a stable connection state with no rattling. The housing main body is fitted with the counterpart housing of the counterpart connector. The housing seal is disposed between the housing main body and the counterpart housing fitted with the housing main body. Therefore, the portion where the counterpart housing and the inner housing main body are filled to each other is protected against entrance of moisture.

### Advantageous Effects of Invention

The present invention provides a connector and a connector connection structure that, even if an electric wire is vibrated, suppress influence of the vibration.

### BRIEF DESCRIPTION OF DRAWINGS

FIG. 1 illustrates a connector connection structure.

FIG. 2 illustrates the connector connection structure in a divided state.

FIG. 3 illustrates the connector connection structure in a divided state.

FIG. 4 is an exploded perspective view of a device-side connector.

FIG. 5 is an exploded perspective view of a harness-side connector.

FIG. 6 is an exploded perspective view of the harness-side connector.

FIG. 7 illustrates an electric wire retaining portion.

FIG. 8 is a cross-sectional view taken along line A-A in FIG. 1(a).

FIG. 9 illustrates a procedure of assembling the harness-side connector.

FIG. 10 illustrates a procedure of assembling the harness-side connector.

FIG. 11 illustrates the procedure of assembling the harness-side connector.

FIG. 12 illustrates the procedure of assembling the harness-side connector.

FIG. 13 illustrates the procedure of assembling the harness-side connector.

FIG. 14 illustrates the procedure of assembling the harness-side connector.

### DESCRIPTION OF EMBODIMENTS

An embodiment of the present invention will be described in detail with reference to the drawings.

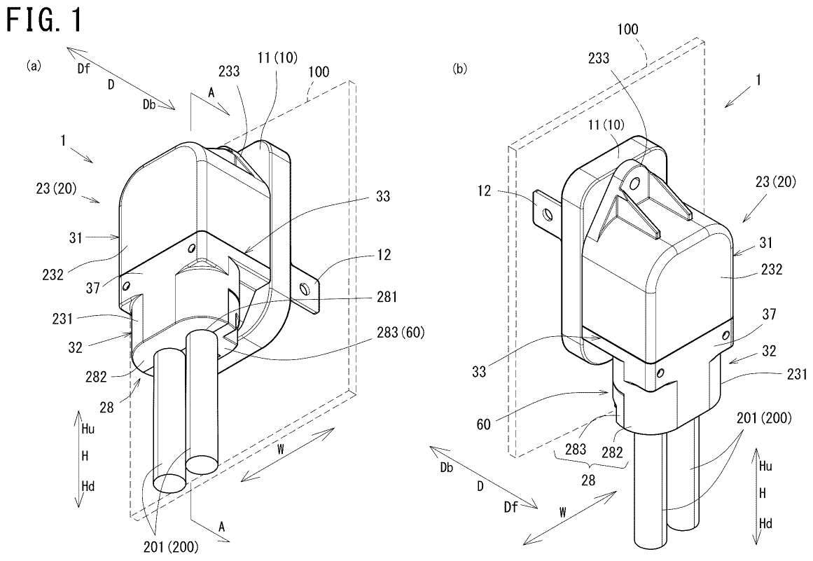

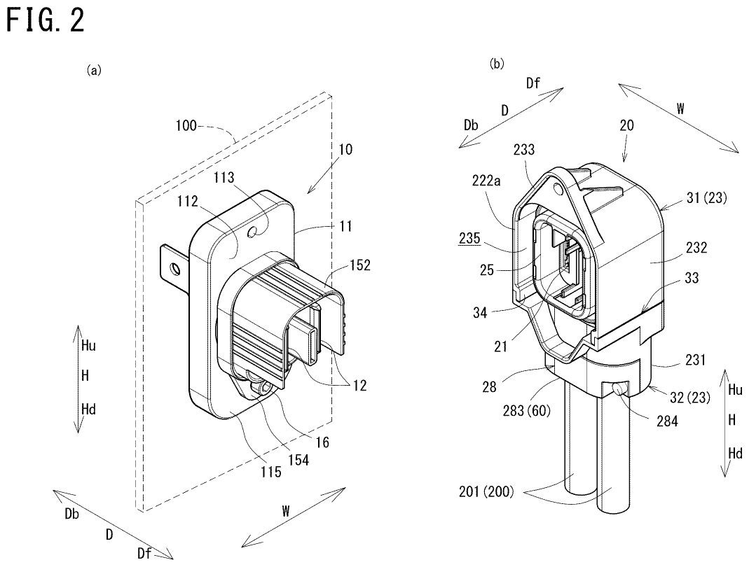

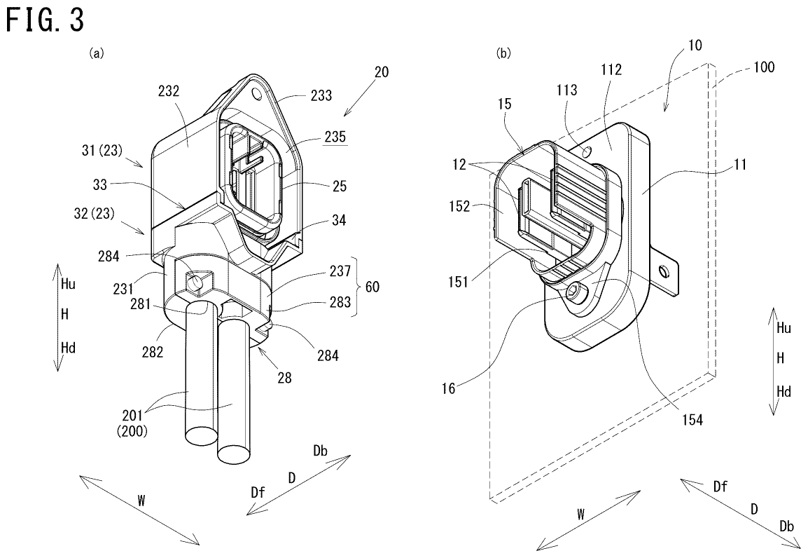

FIG. 1 illustrates a connector connection structure 1, and FIG. 2 and FIG. 3 each illustrate the connector connection structure 1 in a divided state.

In more detail, FIG. 1(a) is a perspective view showing a front surface, a right side surface and a bottom surface of the connector connection structure 1, and FIG. 1(b) is a perspective view showing the front surface, a left side surface and a top surface of the connector connection structure 1.

FIG. 2 includes perspective views illustrating the connector connection structure 1 in a divided state as seen from an upward side Hu. In more detail, FIG. 2(a) is a perspective view showing a front surface, a left side surface and a top surface of a device-side connector 10. FIG. 2(b) is a perspective view showing a rear surface, a left side surface and a top surface of a harness-side connector 20.

FIG. 3 includes perspective views illustrating the connector connection structure 1 in a divided state as seen from a downward side Hd. In more detail, FIG. 3(a) is a perspective view showing the rear surface, a right side surface and a bottom surface of the harness-side connector 10. FIG. 3(b) is a perspective view showing the front surface, a right side surface and a bottom surface of the device-side connector 10.

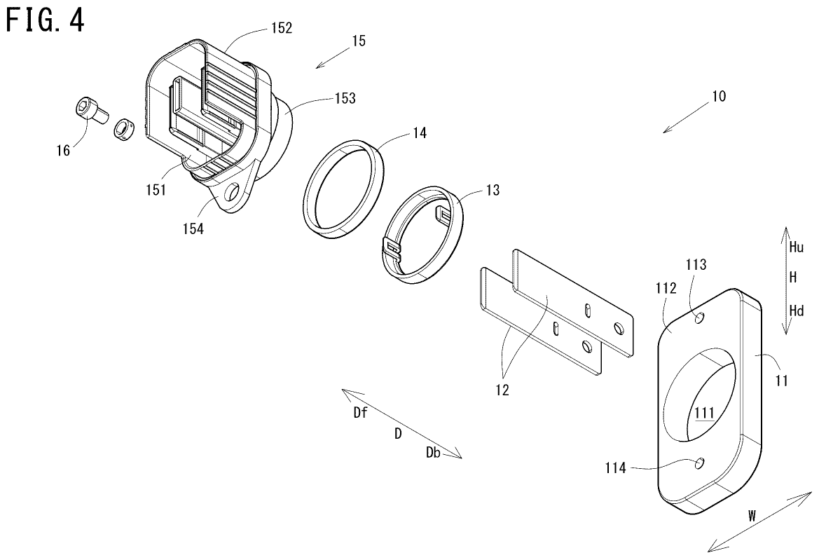

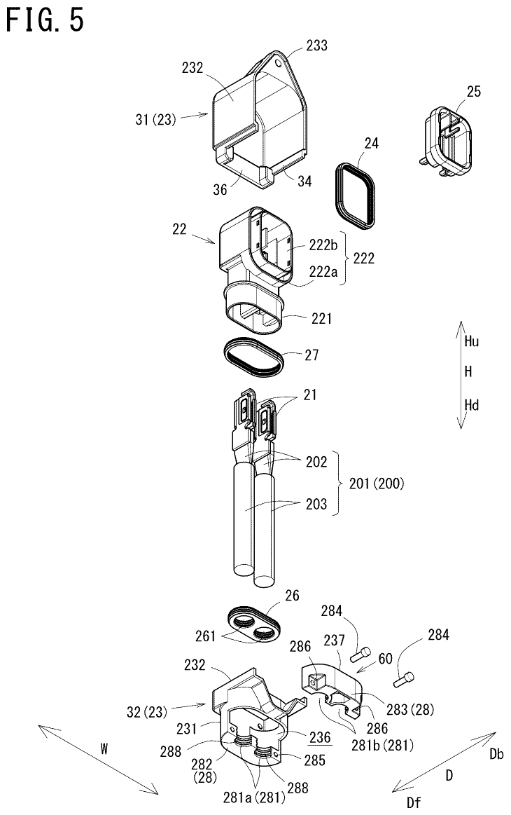

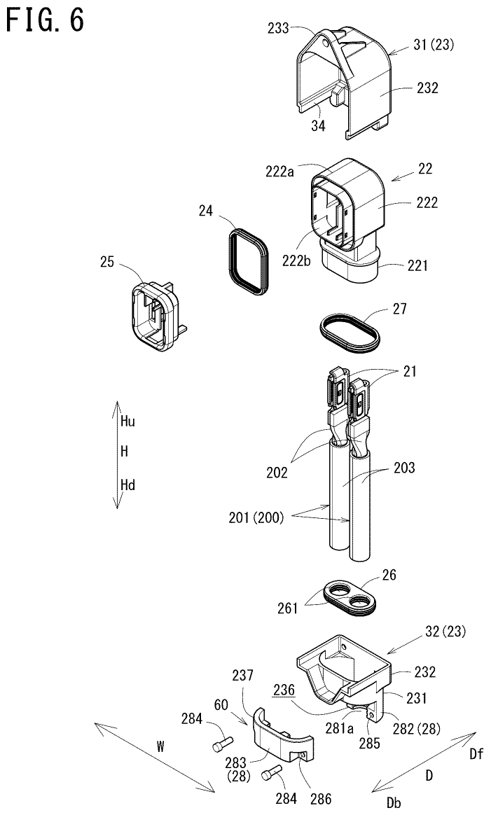

FIG. 4 is an exploded perspective view of the device-side connector 10 showing the front surface, the right side surface and the bottom surface thereof. FIG. 5 is an exploded perspective view of the harness-side connector 20 showing the rear surface, the right side surface and the bottom surface thereof in an exploded state. FIG. 6 is also an exploded perspective view of the harness-side connector 20 showing the rear surface, the left side surface and the top surface thereof in an exploded state.

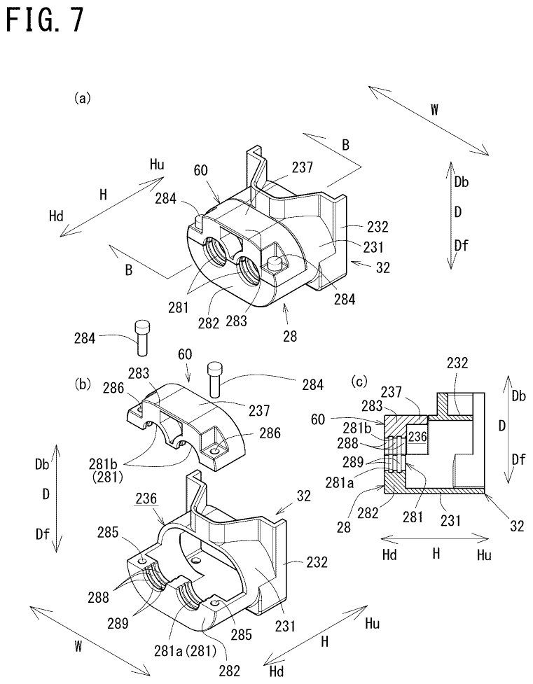

FIG. 7 illustrates an electric wire retaining portion 28. In more detail, FIG. 7(a) shows a rear surface, a bottom surface and a left side surface of the electric wire retaining portion 28. FIG. 7(b) shows the rear surface, the bottom surface and the left side surface of the electric wire retaining portion 28 in an exploded state. FIG. 7(c) shows a cross-section of FIG. 7(a) taken along line B-B in FIG. 7(a).

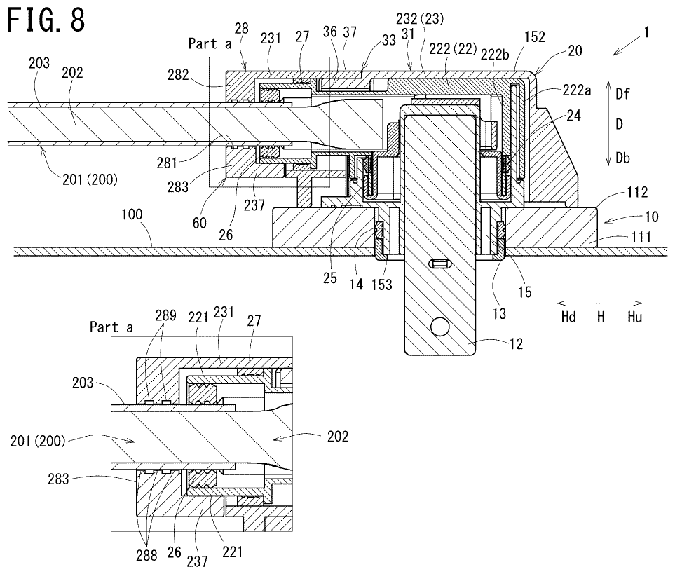

FIG. 8 shows a cross-sectional view taken along line A-A in FIG. 1(a) and an enlarged view of part “a”.

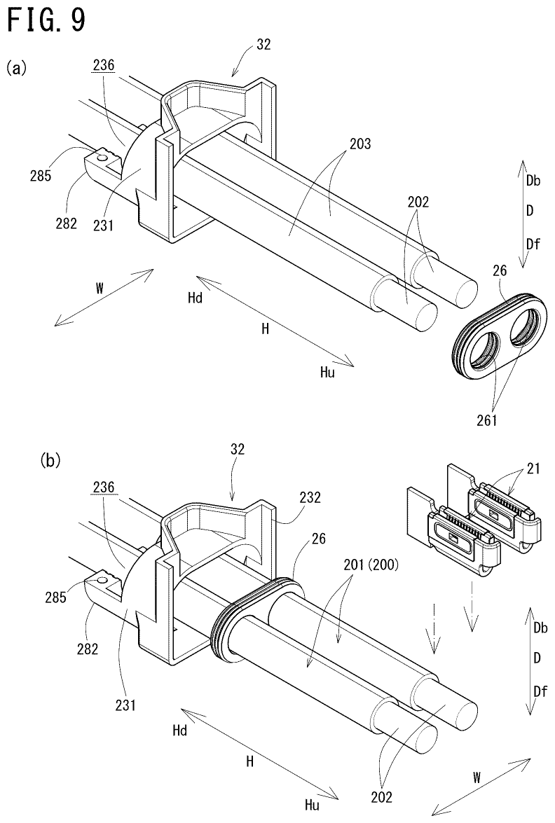

FIG. 9 through FIG. 14 illustrate a procedure of assembling the harness-side connector 20.

In more detail, FIG. 9(a) is a perspective view, as seen from the side of the top surface and the rear surface, of a state where a lower shell 32 including the electric wire retaining portion 28 is outserted over a wire harness 200 in advance. FIG. 9(b) is a perspective view, as seen from the side of the top surface and the rear surface, of a state where a wire seal 26 is outserted over the wire harness 200 in advance but harness-side terminals 21 have not been attached yet.

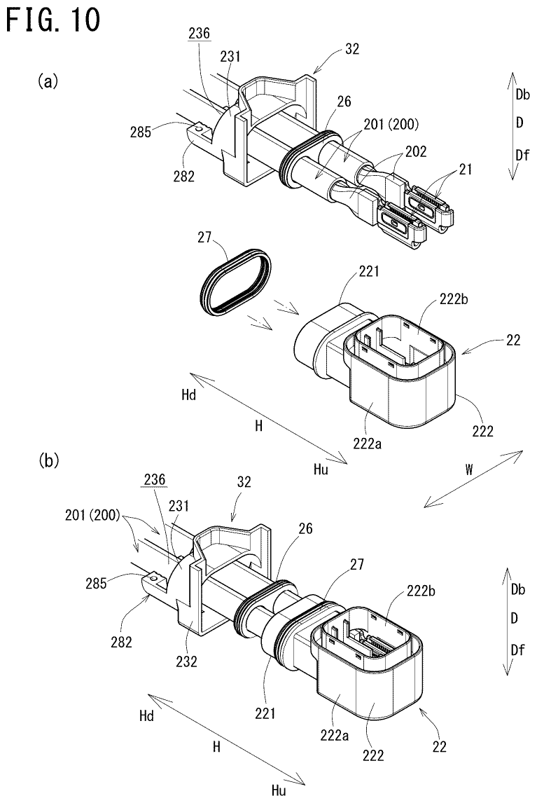

FIG. 10(a) is a perspective view, as seen from the side of the top surface and the rear surface, of a state where the harness-side terminals 21 are attached to electric wires 202 at a tip of the wire harness 200 but a shell seal 27 has not been attached yet to a harness insertion cylinder 221 of a female inner housing 22. FIG. 10(b) is a perspective view, as seen from the side of the rear surface, of a state where the female inner housing 22 having the shell seal 27 attached thereto is attached to the wire harness 200.

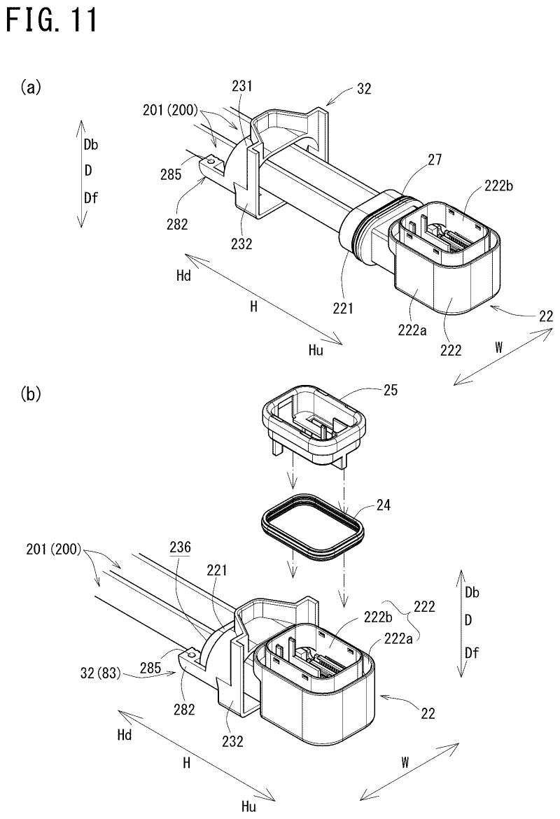

FIG. 11(a) is a perspective view, as seen from the side of the top surface and the rear surface, of a state where the wire seal 26 outserted in advance is disposed at a predetermined position. FIG. 11(b) is a perspective view, as seen from the side of the top surface and the rear surface, of a state where the lower shell 32 is disposed at a predetermined position with respect to the female inner housing 22, to which the lower shell 32 is attached, but neither a housing seal 24 nor a housing seal cover 25 has been attached yet.

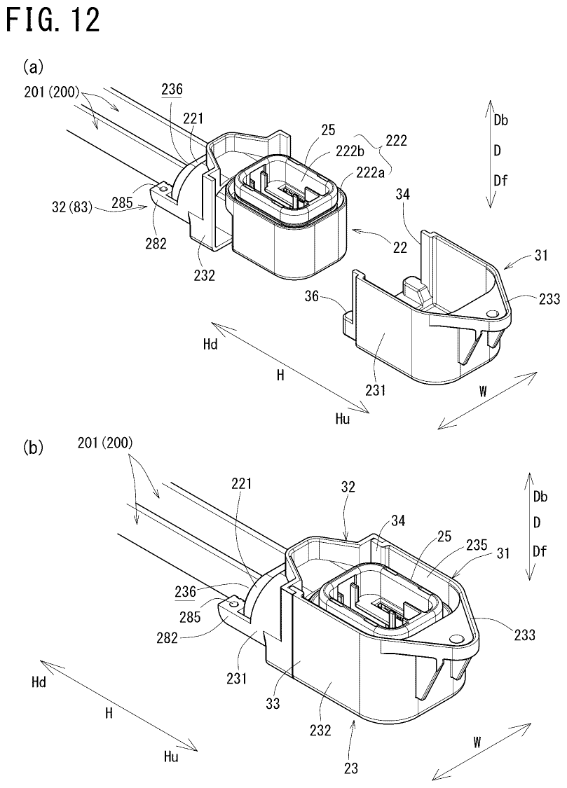

FIG. 12(a) is a perspective view, as seen from the side of the top surface and the rear surface, of a state where the housing seal 24 and the housing seal cover 25 are attached to the female inner housing 22 but an upper shell 31, forming a housing shell 23 together with the lower shell 32, has not been attached yet.

FIG. 12(b) is a perspective view, as seen from the side of the top surface and the rear surface, of a state where the upper shell 31 is attached to the lower shell 32 disposed at the predetermined position.

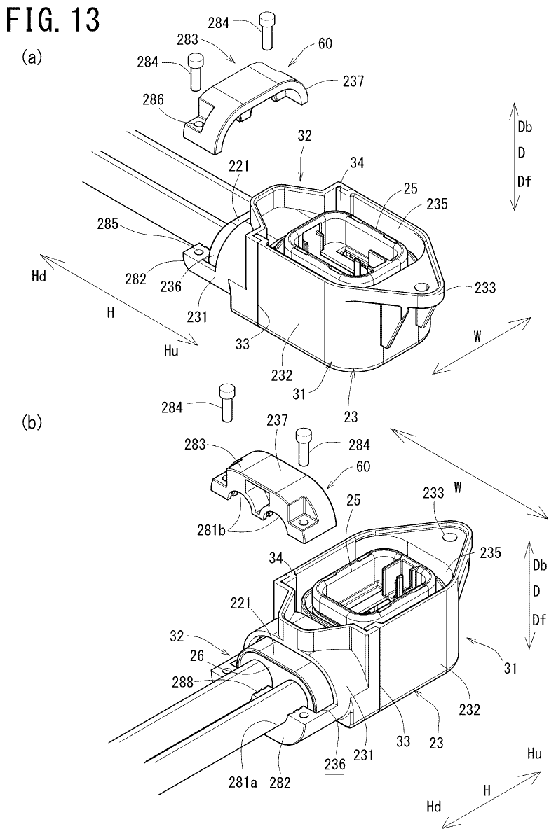

FIG. 13(a) is a perspective view, as seen from the side of the top surface and the rear surface, of a state where a retaining cover 60 included in the electric wire retaining portion 28 is attached. FIG. 13(b) is a perspective view, as seen from the side of the bottom surface and the rear surface, of the same state, that is, the state where the retaining cover 60 included in the electric wire retaining portion 28 is attached.

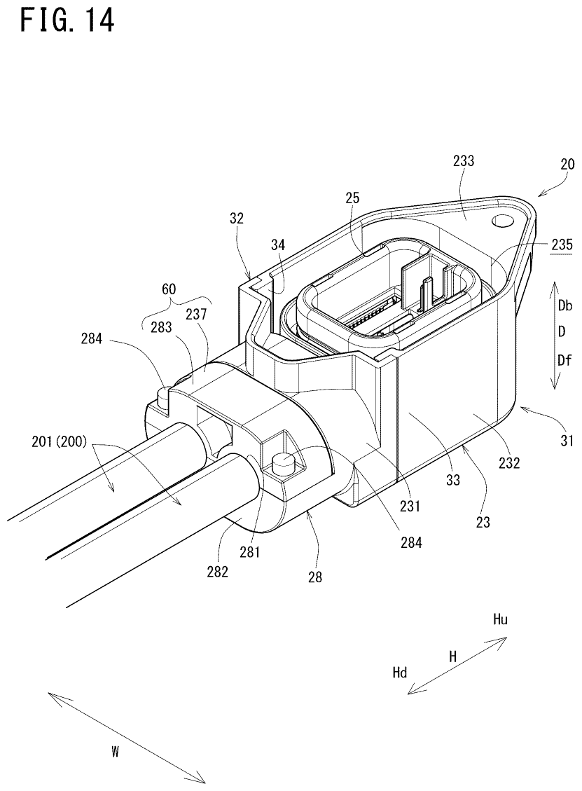

FIG. 14 is a perspective view, as seen from the side of the bottom surface and the rear surface, of a state where the retaining cover 60 including an attachment retaining portion 283 is attached to a securing-side retaining portion 282 and thus the assembly of the harness-side connector 20 is finished.

In FIG. 1(a), arrows H extending in an up-down direction represent a height direction, arrows W extending from bottom-left to top-right represent a width direction, and arrows D extending from bottom-right to top-left represent a depth direction. Arrow Hu of the arrows H extending in the up-down direction represents an upward side of the height direction, and arrow Hd of the arrows H extending in the up-down direction represents a downward side of the height direction. Arrow Db of the arrows D extending from bottom-right to top-left represents a backward side of the depth direction, and arrow Df of the arrows D extending from bottom-right to top-left represents a forward side of the depth direction.

The height direction H, the width direction W and the depth direction D used to describe the configuration of the connector connection structure 1 represent the following directions for the sake of convenience. The depth direction D is a direction in which the device-side connector 10 and the hardness-side connector 20 are attached to, or detached from, each other. The backward side Db is a direction in which the harness-side connector 20 is attached to the device-side connector 10, and the forward side Df is a direction in which the harness-side connector 20 is detached from the device-side connector 10. The width direction W and the height direction H are perpendicular to the depth direction D. These directions do not restrict any direction regarding the configurations of the device-side connector 10, the hardness-side connector 20 and the connector connection structure 1.

As shown in FIG. 1, a connector connection structure 1 is to connect, for example, a device-side connector 10 provided in a device mounted on an automobile, such as an electric device, i.e., a motor or the like, or a power supply device, and a harness-side connector 20 attached to a wire harness 200 including a bundle of covered electric wires, to each other.

As shown in FIG. 2 and FIG. 3, the device-side connector 10 is attached to a device housing 100 of the electric device (represented with dashed lines in FIG. 1 and FIG. 3).

As shown in FIG. 4, the device-side connector 10 includes an attachment pedestal 11, device-side terminals 12, a restriction ring 13, a device-side seal 14, a male housing 15, and a securing bolt 16.

The attachment pedestal 11 is to be attached to the device housing 100 represented with the dashed line and thus to secure the male housing 15 and the harness-side connector 20 described below.

The attachment pedestal 11 has a rectangular shape longer in the height direction H than in the width direction W, and has a predetermined thickness in the depth direction D. The attachment pedestal 11 has a through-hole 111 running therethrough in the depth direction D at a center as seen from the side of the front surface.

A portion of the attachment pedestal 11 that is on the upward side Hu with respect to the through-hole 111 is defined as a securing portion 112 securing the harness-side connector 20 to be attached thereto. The securing portion 112 has a tightening hole 113, through which the harness-side connector 20 is to be secured to the attachment pedestal 11 with a bolt.

A portion of the attachment pedestal 11 that is on the downward side Hd with respect to the through-hole 111 has a tightening hole 114, through which the male housing 15 is to be secured to the attachment pedestal 11 with a securing bolt 16.

The attachment pedestal 11 having such a configuration is formed of a metal material so as to be connected with the harness-side connector 20 described above in an electrically conductive manner and thus provide an electromagnetic shield function when the harness-side connector 20 is attached to the attachment pedestal 11.

The device-side terminals 12 are to be electrically connected with a main body of the electric device disposed in the device housing 100 and are also to be connected with harness-side terminals 21 disposed in the harness-side connector 20. There are two device-side terminals 12 that are away from each other by a predetermined interval in the width direction W.

The restriction ring 13 is to restrict the position, in the depth direction D, of the device-side seal 14 to be attached to an insertion cylinder 153 of the male housing 15 described below, and has a cylindrical shape to be outserted over the insertion cylinder 153.

The device-side seal 14 is to be attached to the insertion cylinder 153 of the male housing 15 described below, and thus to seal a space between the insertion cylinder 153 of the male housing 15 and the attachment pedestal 11. The device-side seal 14 is ring-shaped and formed of rubber.

The male housing 15 is to retain the device-side terminals 12 to the attachment pedestal 11. The male housing 15 includes a retaining portion 151 retaining the device-side terminals 12, a hood 152 enclosing the retaining portion 151, the insertion cylinder 153, of a cylindrical shape, to be inserted into the through-hole 111 of the attachment pedestal 11, and a securing protrusion 154, which protrudes toward the downward side Hd in the height direction H.

The retaining portion 151 is configured to retain the device-side terminals 12, disposed at the predetermined interval in the width direction W, in a state where the device-side terminals 12 are insulated from each other.

The hood 152 has a shape of an enclosing wall with an opening formed on the forward side Df.

The securing protrusion 154 is a member to which the securing bolt 16, securing the male housing 15 to the attachment pedestal 11, is attached.

The device-side connector 10 having such a configuration is assembled as follows. The device-side terminals 12 are put into the retaining portion 151 of the male housing 15, and the device-side seal 14 and the restriction ring 13 are outserted over the insertion cylinder 153.

Then, the insertion cylinder 153 of the male housing 15 having the device-terminals 12, the restriction ring 13 and the device-side seal 14 assembled thereto is inserted into the through-hole 111 of the attachment pedestal 11, and the securing bolt 16 attached to the securing protrusion 154 is screwed into the tightening hole 114. As a result, the attachment pedestal 11 and the male housing 15 are secured to each other. Thus, the assembly of the device-side connector 10 is finished.

As shown in FIG. 1, the harness-side connector 20 is to be attached to the above-described device-side connector 10 to form the connector connection structure 1. The harness-side connector 20 connects the device-side terminals 12 of the device-side connector 10 and the harness-side terminals 21 of the harness-side connector 20 to each other.

As shown in FIG. 5 and FIG. 6, the harness-side connector 20 includes a wire harness 200, the harness-side terminals 21, the female inner housing 22, the housing shell 23, the housing seal 24, the housing seal cover 25, the wire seal 26, the shell seal 27, and the electric wire retaining portion 28.

The harness-side terminals 21 are high-voltage terminals attached to electric wires 202 exposed from the tips of the high-voltage electric wires 201 each including an electric wire 202 and an insulating cover 203 covering the electric wire 202. In the case where the wire harness 200 includes two high-voltage electric wires 201, one harness-side terminal 21 is attached to each of the high-voltage electric wires 201, and thus the harness-side connector 20 includes two harness-side terminals 21.

The female inner housing 22 is to retain the two harness-side terminals 21 at predetermined positions in the harness-side connector 20. The female inner housing 22 includes a harness insertion cylinder 221, into which the wire harness 200 is to be inserted, and a retaining portion main body 222, in which the harness-side terminals 21, provided at a tip of the wire harness 200 inserted into the harness insertion cylinder 221, are to be disposed. The female inner housing 22 is formed of a resin.

The harness insertion cylinder 221 has a cylindrical shape that has an opening at an end on the downward side Hd (bottom end) and has an elliptical shape (ellipsoidal shape with two straight portions) as seen from the side of the bottom surface. An end on the upward Hu (top end) of the harness insertion cylinder 221 is in communication with the inside of the retaining portion main body 222.

The retaining portion main body 222 is disposed at the end on the upward side Hu of the harness insertion cylinder 221, and has a generally cuboidal shape with an opening formed on the backward side Db. The retaining portion main body 222 is configured to retain the harness-side terminals 21 therein.

The retaining portion main body 222 includes an outer wall 222a and an inner wall 222b, and is configured to retain the harness-side terminals 21 inside the inner wall 222b.

Between the outer wall 222a and the inner wall 222b, there is a space into which the hood 152 of the male housing 15 of the device-side connector 10 is to be inserted, in a state where the device-side connector 10 and the harness-side connector 20 are assembled together.

The housing shell 23 is to cover an outer surface of the female inner housing 22 and is to form an outer shape of the harness-side connector 20.

The housing shell 23 is larger than the female inner housing 22 to some extent. The housing shell 23 includes a harness insertion outer cylinder 231, a shell main body 232, and a connector securing portion 233.

This will be described in more detail. The harness insertion outer cylinder 231 has a cylindrical shape that is elliptical as seen from the side of the bottom surface and has an opening formed at an end thereof on the downward side Hd. The harness insertion outer cylinder 231 is larger than the harness insertion cylinder 221 to some extent such that the harness insertion cylinder 221, into which the wire harness 200 is to be inserted, is disposed in the harness insertion outer cylinder 231. An end of the harness insertion outer cylinder 231 on the upward side Hu is in communication with the inside of the shell main body 232.

On the downward side Hd of the harness insertion outer cylinder 231, a half, on the backward side Db, of the cylinder having an elliptical shape as seen from the side of the bottom surface is opened to form an opening 236. The electric wire retaining portion 28 described below is provided at the end on the downward side Hd of the harness insertion outer cylinder 231.

The shell main body 232 is to be disposed at the end on the upward side Hu of the harness insertion outer cylinder 231. The shell main body 232 has a generally cuboidal shape with an opening formed on the backward side Db. The shell main body 232 is larger, to some extent, than the retaining portion main body 222 to be disposed therein.

The opening formed on the backward side Db of the shell main body 232 having the generally cuboidal shape is a fitting opening 235, from which the harness-side terminals 21 are exposed toward the backward side Db.

The connector securing portion 233 is triangular as seen from the side of the front surface and protrudes toward the upward side Hu from the shell main body 232. The connector securing portion 233 has a plate-like shape, and a bolt (not shown) is to be attached to the connector securing portion 233 to secure the housing shell 23 to the attachment pedestal 11.

The housing shell 23 enclosing the female inner housing 22 is formed of a metal material so as to be electrically conductive with the attachment pedestal 11 and provide an electromagnetic shield function when the housing shell 23 is attached to the attachment pedestal 11 and the connector securing portion 233 is secured, with a bolt, to the securing portion 112 of the attachment pedestal 11.

The housing shell 23 having such a configuration is assembled as follows. Divided shells 31 and 32, which are parts of the shell main body 232 separated from each other in the height direction H, are assembled together.

This will be described in more detail. The shell main body 232 is divided into two along a phantom horizontal plane (not shown) extending in the width direction W and the depth direction D into the upper shell 31 on the upward side Hu with respect to the phantom horizontal plane and the lower shell 32 on the downward side Hd with respect to the phantom horizontal plane. The upper shell 31 and the lower shell 32 are assembled together in the height direction H. The phantom horizontal plane is at a position close to the end on the upward side Hu of the harness insertion cylinder 221 in the state where the harness-side connector 20 is assembled.

The portion of the shell main body 232 on the upward side Hu with respect to the phantom horizontal plane and the connector securing portion 233 form the upper shell 31, and the portion of the shell main body 232 on the downward side Hd with respect to the phantom horizontal plane and the harness insertion outer cylinder 231 form the lower shell 32. The upper shell 31 and the lower shell 32 are assembled together in the height direction H, along a joining portion 33, to form the housing shell 23.

An end portion on the downward side Hd, of the upper shell 31, that is included in the joining portion 33 and an end portion on the upward side Hu of the lower shell 32, that is included in the joining portion 33 each have a sharp-cornered U shape that is opened toward the backward side Db in the depth direction D as seen in the height direction H. Joining protrusions 34 are formed along edges, among edges of the sharp-cornered U shape, on two side surfaces in the width direction W. The joining protrusions 34 are put along inner surfaces of the end portion on the upward side Hu of the lower shell 32 to form the joining portion 33.

This will be described in more detail. The upper shell 31 has the sharp-cornered U shape as seen from the side of the bottom surface. The side surfaces on the two sides of the upper shell 31 in the width direction W have the edges on the downward side Hd. The joining protrusions 34 are formed along inner surfaces of these edges so as to protrude toward the downward side Hd.

As described above, the joining protrusions 34 are put along the inner surfaces of the end portion on the upward side Hu of the lower shell 32, and the upper shell 31 and the lower shell 32 are joined and assembled together to form the shell main body 232. The upper shell 31, the lower shell 32 and the joining portion 33 of the shell main body 232 thus assembled are flush with each other.

In the upper shell 31 having the sharp-cornered U shape as seen from the side of the bottom surface, a conductive connection piece 36 is provided along an inner surface of an edge on the downward side Hd on the backward side Db. The conductive connection piece 36 protrudes toward the downward side Hd. The connection protrusions 34 provided on the two sides in the width direction W and protruding from the end on the downward side Hd of the upper shell 31 and the conductive connection piece 36 are continuous to each other, and the conductive connection piece 36 has bolt holes to which securing bolts are to be engaged.

In the state where the upper shell 31 and the lower shell 32 are assembled together, the conductive connection piece 36 having such a configuration is disposed on the inner side surface on the backward side Db of the lower shell 32, and is tightened with the bolts. In this manner, conductive connection portion 37 (see FIG. 1), which connects the upper shell 31 and the lower shell 32 to each other in an electrically conductive manner, is formed.

The housing seal 24 has a ring shape that is quadrangular as seen from the side of the front surface, and the quadrangular shape of the housing seal 24 matches the shape of the inner wall 222b of the retaining portion main body 222 as seen from the side of the rear surface. The housing seal 24 is formed of rubber and seals a space between the male housing 15 of the device-side connector 10 and the female inner housing 22 of the harness-side connector 20.

As shown in FIG. 8, the housing seal 24 is outserted over a portion on the forward side Df of the housing seal cover 25 described below. The housing seal cover 25 is attached to the retaining portion main body 222, so that the housing seal 24 is located on the backward side Db of the inner wall 222b and thus is restricted from being pulled off by the housing seal cover 25. In the state where the housing seal cover 25 is attached to the retaining portion main body 222, the housing seal 24 faces the outer wall 222a at an interval. Therefore, in the state where the device-side connector 10 and the harness-side connector 20 are assembled together, the housing seal 24 is in close contact with the hood 152 of the male housing 15. The hood 152 is inserted between the outer wall 222a and the inner wall 222b. In this manner, the housing seal 24 seals a space between the male housing 15 of the device-side connector 10 and the female inner housing 22 of the harness-side connector 20.

The housing seal cover 25 is to be attached to the inner wall 222b of the female inner housing 22 from the backward side Db in the depth direction D, and thus to secure the harness-side terminals 21 disposed in the retaining portion main body 222 of the female inner housing 22. The housing seal cover 25 is attached to the inner wall 222b of the female inner housing 22, and thus locates the housing seal 24, outserted over the portion of the housing seal cover 25 on the forward side Df, at a tip of the inner wall 222b.

The wire seal 26 has insertion holes 261, into which the two high-voltage electric wires 201 are to be inserted. The wire seal 26 is to seal a space between the high-voltage electric wires 201 inserted into the harness insertion cylinder 221 and an inner surface of the harness insertion cylinder 221. Therefore, the wire seal 26 is formed to be elliptical so as to be disposed in the harness insertion cylinder 221.

The shell seal 27 is to be outserted over the harness insertion cylinder 221 of the female inner housing 22 and thus to seal a space between the harness insertion cylinder 221 and the harness insertion outer cylinder 231. The shell seal 27 is formed to be elliptical so as to be outserted over the harness insertion cylinder 221.

The electric wire retaining portion 28 provided at the end on the downward side Hd of the harness insertion outer cylinder 231 is to retain the high-voltage electric wires 201, inserted into the harness insertion cylinder 221, in the harness insertion outer cylinder 231, and has electric wire insertion holes 281, into which the high-voltage electric wires 201 are to be inserted.

Two electric wire insertion holes 281 are provided, in accordance with the two high-voltage electric wires 201 included in the wire harness 200 at a predetermined interval in the width direction W. The electric wire insertion holes 281 are each formed to have a diameter equal to, or slightly shorter than, an outer diameter of the corresponding high-voltage electric wire 201, and an inner surface of each of the electric wire insertion holes 281 has ribs 288 (see FIG. 5 and FIG. 7), which eat into an outer surface of the corresponding high-voltage electric wire 201, that is, the corresponding insulating cover 203.

The electric wire retaining portion 28 has the electric wire insertion holes 281 formed therein on the downward side Hd of the harness insertion outer cylinder 231. The electric wire insertion holes 281 retain the high-voltage electric wires 201 inserted thereinto. The electric wire retaining portion 28 includes the securing-side retaining portion 282 and the attachment retaining portion 283 on the downward side Hd of the harness insertion outer cylinder 231. The securing-side retaining portion 282 is integrally formed with the harness insertion outer cylinder 231. The attachment retaining portion 283 is attached to the securing-side retaining portion 282.

The securing-side retaining portion 282 has securing-side arcked grooves 281a, which form a half on the forward side Df of the electric wire insertion holes 281. The attachment retaining portion 283 has attachment-side arcked grooves 281b, which form a half on the backward side Db of the electric wire insertion holes 281.

Specifically, the electric wire retaining portion 28 includes the securing-side retaining portion 282, the attachment retaining portion 283 and securing bolts 284. The securing-side retaining portion 282 is integrally formed with the harness insertion outer cylinder 231 at the end on the downward side Db of the harness insertion outer cylinder 231. The attachment retaining portion 283 is separately formed from the securing-side retaining portion 282 and assembled with, and secured to, the securing-side retaining portion 282. The securing bolts 284 tighten and secure the attachment retaining portion 283 assembled with the securing-side retaining portion 282. The attachment retaining portion 283 is integrally formed with a cover 237 closing the opening 236 of the harness insertion outer cylinder 231, and thus forms the retaining cover 60.

The securing-side retaining portion 282 is provided at an end on the downward side Hd of the harness insertion outer cylinder 231, which has a cylindrical shape having an elliptical cross-section as seen from the downward side Hd. The securing-side retaining portion 282 has a cross-section of a semi-elliptical shape that is a half on the forward side Df of the elliptical shape. The securing-side retaining portion 282 is obtained as a result of the downward side Hd portion of the harness insertion outer cylinder 231 being divided along a plane perpendicular to the width direction D. The securing-side retaining portion 282 is formed to have a predetermined thickness in the height direction H. The securing-side retaining portion 282 having such a semi-elliptical shape on the forward side Df of the harness insertion outer cylinder 231 has the securing-side arcked grooves 281a on the backward side Db of the securing-side retaining portion 282. The securing-side arcked grooves 281a are provided at an interval in the width direction W. The securing-side retaining portion 282 has tightening holes 285 outer, in the width direction W, to the securing-side arcked grooves 281a. Through the tightening holes 285, the securing bolts 284 are tightened.

The attachment retaining portion 283 is assembled with the securing-side retaining portion 282 at the end on the downward side Hd of the harness insertion outer cylinder 231, which has the cylindrical shape having the elliptical cross-section as seen from the downward side Hd, to form the electric wire retaining portion 28. The securing-side retaining portion 282 has a cross-section of the semi-elliptical shape that is a half on the forward side Df of the elliptical shape. The securing-side retaining portion 282 is obtained as a result of the downward side Hd portion of the harness insertion outer cylinder 231 being divided along a plane perpendicular to the width direction D. The attachment retaining portion 283 has a cross-section of a semi-elliptical shape that is a half on the backward side Db of the elliptical shape. The attachment retaining portion 283 is formed to have a predetermined thickness in the height direction H, like the securing-side retaining portion 282. The attachment retaining portion 283 having such a semi-elliptical shape on the forward side Df of the harness insertion outer cylinder 231 has the attachment-side arcked grooves 281b on the backward side Db of the attachment retaining portion 283. The attachment-side arcked grooves 281b are provided at an interval in the width direction W. The attachment retaining portion 283 has insertion holes 286 outer, in the width direction W, to the attachment-side arcked grooves 281b. Through the insertion holes 286, the securing bolts 284 are inserted.

As described above, the attachment retaining portion 283 is integrally formed with the cover 237 to form the retaining cover 60.

Specifically, the retaining cover 60 has the following configuration. The cover 237 is located on the upward side Hu. The cover 237 is attached to the opening 236 formed in the harness insertion outer cylinder 231. The attachment retaining portion 283 is located on the downward side Hd of the cover 237.

The retaining cover 60 covers the opening 236, in the harness insertion outer cylinder 231 of the housing shell 23 formed of a metal material, with the cover 237. The retaining cover 60 is formed of an electrically conductive metal material, like the housing shell 23. In an assembled state, the retaining cover 60 is electrically conductive with the housing shell 23.

The retaining cover 60 having such a configuration is assembled with the harness insertion outer cylinder 231, and as a result, the electric wire retaining portion 28 having a cylindrical shape is formed. The securing bolts 284 are inserted into the insertion holes 286 of the attachment retaining portion 283 and are screwed with the tightening holes 285 of the securing-side retaining portion 282. As a result, the retaining cover 60 is tightened to the harness insertion outer cylinder 231. In the state where the retaining cover 60 is tightened to the harness insertion outer cylinder 231, the opening 236 formed in the harness insertion outer cylinder 231 is covered with the cover 237 of the retaining cover 60 to form the cylindrical shape, and the securing-side retaining portion 282 and the attachment retaining portion 283 in an assembled state are tightened and secured to each other.

The ribs 288 provided on the inner surfaces of the electric wire insertion holes 281 formed in the electric wire retaining portion 28 are to locally press the insulating covers 203 of the high-voltage electric wires 201, and are formed in a circumferential direction.

This will be described in more detail. In the inner surfaces of the electric wire insertion holes 281, circumferential grooves 289 extending in the circumferential direction are formed at a predetermined interval in the height direction H. The ribs 288 are formed on both of two outer sides, in the height direction H, of the circumferential grooves 289 and also between the circumferential grooves 289.

The ribs 288 and the circumferential grooves 289 are formed at both of the securing-side arcked grooves 281a and the attachment-side arcked grooves 281b, which define the electric wire insertion holes 281. In a state where the securing-side retaining portion 282 and the attachment retaining portion 283 are assembled together to form the electric wire retaining portion 28, the ribs 288 and the circumferential grooves 289 continuous in the circumferential direction are formed in the inner surfaces of the electric wire insertion holes 281.

The above-described elements may be assembled as described below to form the harness-side connector 20.

The housing seal 24 is outserted over the inner wall 222b of the retaining portion main body 222 of the female inner housing 22 and is disposed between the outer wall 222a and the inner wall 222b. The housing cover seal 25 is attached to an opening side of the inner wall 222b.

The high-voltage electric wires 201 are inserted into the insertion holes 261 of the wire seal 26, and the wire seal 26 is attached to the wire harness 200. The shell seal 27 is outserted over the harness insertion cylinder 221 of the female inner housing 22.

The wire harness 200 including the high-voltage electric wires 201 having the harness-side terminals 21 attached at the tips thereof is inserted into the harness insertion outer cylinder 231 of the housing shell 23 and the harness insertion cylinder 221 of the female inner housing 22, and attached to the female inner housing 22 such that the harness-side terminals 21 are disposed in the retaining portion main body 222.

The female inner housing 22 is disposed in the housing shell 23 including the upper shell 31 and the lower shell 32 assembled together at the joining portion 33. The retaining portion main body 222 of the female inner housing 22 is disposed in the shell main body 232 of the housing shell 23, and the harness insertion cylinder 221 is disposed in the harness insertion outer cylinder 231 of the housing shell 23.

At this point, the end on the downward side Hd of the harness insertion cylinder 221 is disposed on the upward side Hu with respect to the securing-side retaining portion 282 provided at the end on the downward side Hd of the harness insertion outer cylinder 231, and is exposed from the opening 236 in a state before the retaining cover 60 is attached (see FIG. 13(b)).

The retaining cover 60 is assembled with the end on the downward side Hd of the harness insertion outer cylinder 231 and the securing bolts 284 are screwed thereto, and thus the retaining cover 60 is tightened and secured to the harness insertion outer cylinder 231. As a result, the opening 236 of the harness insertion outer cylinder 231 is covered with the cover 237 to form the cylindrical shape. The retaining cover 60 is assembled, tightened and secured to the harness insertion outer cylinder 231. As a result, the securing-side retaining portion 282 provided at the end on the downward side Hd of the harness insertion outer cylinder 231 and the attachment retaining portion 283 of the retaining cover 60 form the electric wire retaining portion 28.

In the electric wire retaining portion 28 thus formed, the ribs 288 provided on the inner surfaces of the electric wire insertion holes 281 of the electric wire retaining portion 28 locally press the outer circumferential surfaces of the high-voltage electric wires 201 inserted into the electric wire insertion holes 281. As a result, the high-voltage electric wires 201 are secured to the harness insertion outer cylinder 231.

The harness insertion cylinder 221, of the female inner housing 22, exposed from the opening 236 contacts the cover 237 of the retaining cover 60 covering the opening 236, and thus is retained while being sandwiched between the harness insertion outer cylinder 231 and the cover 237.

The harness-side connector 20 assembled in this manner and the device-side connector 10 are fitted into each other, and thus the connector securing portion 233 of the housing shell 23 of the harness-side connector 20 is secured by a bolt (not shown) to the tightening hole 113 of the attachment pedestal 11.

In this manner, the device-side terminals 12 of the device-side connector 10 and the harness-side terminals 21 located in the retaining portion main body 222 of the harness-side connector 20 are connected to each other. As a result, as shown in FIG. 1 and FIG. 8, the connector connection structure 1 including the device-side connector 10 and the harness-side connector 20 electrically conductive to each other is formed.

A procedure of assembling the harness-side connector 20, which is to be fitted to the device-side connector 10 as described above to form the connector connection structure 1, will be described with reference to FIG. 9 through FIG. 14.

First, as shown in FIG. 9(a), the lower shell 32 is outserted over the wire harness 200 in advance. As shown in FIG. 9(b), the high-voltage electric wires 201 are inserted into the insertion holes 261, and the wire seal 26 is outserted over the high-voltage electric wires 201 in advance. At this point, the high-voltage electric wires 201 included in the wire harness 200 do not have the harness-side terminals 21 attached to at the tips thereof, and the electric wires 202 are exposed at the tips.

As shown in FIG. 10(a), the harness-side terminals 21 are attached to the electric wires 202 at the tip of the wire harness 200. Then, the shell seal 27 is attached to the harness insertion cylinder 221 of the female inner housing 22.

The attachment of the shell seal 27 to the harness insertion cylinder 221 and the attachment of the lower shell 32 to the wire harness 200 may be performed at any time before the step of assembling the upper shell 31 and the lower shell 32 to each other so as to house the female inner housing 22 attached to the harness-side connector 20.

The harness-side terminals 21 may be attached to the electric wires 202 exposed from the tips of the high-voltage electric wires 201 by, for example, ultrasonic vibration welding or the like. The above description is made with an assumption that until the step of attaching the harness-side terminals 21 to the electric wires 202 exposed from the tips of the high-voltage electric wires 201, the electric wires 202 are exposed from the tips of the high-voltage electric wires 201. Alternatively, in the step of attaching the harness-side terminals 21, the insulating covers 203 at the tips may be peeled off by a predetermined length to expose the electric wires 202, and then the harness-side terminals 21 may be attached.

As shown in FIG. 10(b), the female inner housing 22 having the shell seal 27 attached thereto is attached to the wire harness 200. As shown in FIG. 11(a), the wire seal 26 outserted in advance is disposed at a predetermined position in the harness insertion cylinder 221.

The predetermined position is the position at which the wire seal 26 is inserted from the end on the downward side Hd of the harness insertion cylinder 221 toward the upward side Hu. At this position, the wire seal 26 seals a space between the high-voltage electric wires 201 inserted into the insertion holes 261 and the harness insertion cylinder 221.

Next, as shown in FIG. 11(b), the lower shell 32 is disposed at a predetermined position with respect to the above-attached female inner housing 22. The housing seal 24 and the housing seal cover 25 are attached to the inner wall 222b of the female inner housing 22 (see FIG. 12(a)).

At this point, the two high-voltage electric wires 201 are disposed at the securing-side arcked grooves 281a of the securing-side retaining portion 282 provided at the end on the downward side Hd of the harness insertion outer cylinder 231 of the lower shell 32.

The attachment of the housing seal 24 and the housing seal cover 25 to the inner wall 222b of the female inner housing 22 may be performed at any time after the female inner housing 22 is attached to the high-voltage electric wires 201.

As shown in FIG. 12(b), the joining protrusions 34 and the conductive connection piece 36 are put along a circumferential edge of the lower shell 32 disposed at the predetermined position, and the upper shell 31 is fitted into, and attached to, the lower shell 32 by the joining portion 33. At this point, the conductive connection piece 36 on the forward side Df of the upper shell 31 and the lower shell 32 are tightened together by a bolt (not shown), and thus the upper shell 31 and the lower shell 32 are assembled together and secured to each other. As a result, the housing shell 23 is formed.

As shown in FIG. 13(a) and FIG. 13(b), the retaining cover 60 including the attachment retaining portion 283 included in the electric wire retaining portion 28 is attached to a predetermined position with respect to the harness insertion outer cylinder 231 of the housing shell 23 formed by the upper shell 31 and the lower shell 32 being secured to each other.

This will be described in more detail. The attachment retaining portion 283 included in the retaining cover 60 is assembled with the securing-side retaining portion 282, and the securing bolts 284 are inserted into the insertion holes 286 provided in the attachment retaining portion 283 to be screwed with the tightening holes 285 provided in the securing-side retaining portion 282. As a result, as shown in FIG. 14, the attachment retaining portion 283 is tightened and secured to the securing-side retaining portion 282. Thus, the assembly of the harness-side connector 20 is finished.

That is, the retaining cover 60 is tightened and secured to the harness insertion outer cylinder 231, and the opening 236 of the harness insertion outer cylinder 231 is covered with the cover 237 of the retaining cover 60 to form the electric wire retaining portion 28 having the cylindrical shape.

The electric wire retaining portion 28 assembled in this manner has the electric wire insertion holes 281, which are circular as seen from the downward side Hd. The electric wire insertion holes 281 is defined by the securing-side arcked grooves 281a of the securing-side retaining portion 282 and the attachment-side arcked grooves 281b of the attachment retaining portion 283. Therefore, the high-voltage electric wires 201 disposed at the securing-side arcked grooves 281a of the securing-side retaining portion 282 are inserted into the electric wire insertion holes 281. The high-voltage electric wires 201 are sandwiched between the securing-side arcked grooves 281a and the attachment-side arcked grooves 281b. The ribs 288 provided on the inner surfaces of the electric wire insertion holes 281 locally press the electric wires 202 of the high-voltage electric wires 201, and thus the high-voltage electric wires 201 are retained by the electric wire retaining portion 28.

As described above, the harness-side connector 20 includes the high-voltage electric wires 201 each having the harness-side terminal 21 attached to the tip thereof; and the female inner housing 22 and the housing shell 23 having the harness-side terminals 21 disposed therein. The female inner housing 22 of the harness-side connector 20 includes the retaining portion main body 222 having the harness-side terminals 21 disposed therein and also includes the harness insertion cylinder 221, which is in communication with the retaining portion main body 222 and into which the high-voltage electric wires 201 are inserted. The housing shell 23 of the harness-side connector 20 includes the shell main body 232 having the harness-side terminals 21 disposed therein, and also includes the harness insertion outer cylinder 231, which is in communication with the shell main body 232 and into which the high-voltage electric wires 201 are inserted. The electric wire retaining portion 28 retaining the high-voltage electric wires 201 are provided on the harness insertion outer cylinder 231.

The electric wire retaining portion 28 has the electric wire insertion holes 281 retaining the high-voltage electric wires 201 inserted thereinto, and includes the securing-side retaining portion 282 and the attachment retaining portion 283. The securing-side retaining portion 282 is integral with the harness insertion outer cylinder 231 and has the securing-side arcked grooves 281a as a part of the electric wire insertion holes 281. The attachment retaining portion 283 has the attachment-side arcked grooves 281b as another part of the electric wire insertion holes 281, and is attached to the securing-side retaining portion 282.

The connector connection structure 1 includes the high-voltage electric wires 201 having the harness-side terminals 21 at the tips thereof, and also includes the harness-side connector 20 and the device-side connector 10 connected to each other. The harness-side connector 20 includes the female inner housing 22 having the harness-side terminals 21 disposed therein and also includes the housing shell 23. The device-side connector 10 includes the device-side terminals 12, which are connected with the harness-side terminals 21 connected with the retaining portion main body 222 and the shell main body 232. The connector connection structure 1 has the following structure. The female inner housing 22 and the housing shell 23 include the retaining portion main body 222 and the shell main body 232 having the harness-side terminals 21 disposed therein and also includes the harness insertion outer cylinder 231, which is in communication with the retaining portion main body 222 and the shell main body 232 and has the high-voltage electric wires 201 inserted thereto. The electric wire retaining portion 28 retaining the high-voltage electric wires 201 are provided on the harness insertion outer cylinder 231. The electric wire retaining portion 28 has the electric wire insertion holes 281 retaining the high-voltage electric wires 201 inserted thereinto, and includes the securing-side retaining portion 282 and the attachment retaining portion 283. The securing-side retaining portion 282 is provided on the harness insertion outer cylinder 231 and the shell main body 232 and defines a part of the electric wire insertion holes 281. The attachment retaining portion 283 defines the remaining part of the electric wire insertion holes 281, and is attached to the securing-side retaining portion 282.

Therefore, even if the high-voltage electric wires 201 vibrate, the influence of the vibration is suppressed.

This will be described in more detail. The electric wire retaining portion 28 having the electric wire insertion holes 281 retaining the high-voltage electric wires 201 is provided on the harness insertion outer cylinder 231. The harness insertion outer cylinder 231 is included in the housing shell 23, is in communication with the shell main body 232, and has the high-voltage electric wires 201 inserted thereinto. The electric wire retaining portion 28 includes the securing-side retaining portion 282 and the attachment retaining portion 283. The securing-side retaining portion 282 is integral with the harness insertion outer cylinder 231 and has the securing-side arcked grooves 281a as a part of the electric wire insertion holes 281. The attachment retaining portion 283 has the attachment-side arcked grooves 281b as another part of the electric wire insertion holes 281, and is attached to the securing-side retaining portion 282.

Therefore, the attachment retaining portion 283 is attached to the securing-side retaining portion 282, integral with the shell main body 232 via the harness insertion outer cylinder 231, and thus the electric wire retaining portion 28 having the electric wire insertion holes 281 is formed. The high-voltage electric wires 201 are retained in the electric wire insertion holes 281. That is, the attachment retaining portion 283 is attached to the securing-side retaining portion 282 integral with the shell main body 232, and thus the housing shell 23 is formed and also the electric wire retaining portion 28 is formed to retain the high-voltage electric wires 201. Therefore, even if a vibration acts on the high-voltage electric wire 201, the exertion of the influence of the vibration on the female inner housing 22 and the housing shell 23 is suppressed.

The ribs 288 locally pressing the outer surfaces of the high-voltage electric wires 201 are provided on the inner surfaces defining the electric wire insertion holes 281. With such a configuration, in the state where the attachment retaining portion 283 is attached to the securing-side retaining portion 282, the ribs 288 locally press a part of the outer surface of a portion, of each high-voltage electric wire 201, that is inserted into the electric wire insertion hole 281. Therefore, the securing force of the high-voltage electric wires 201 on the electric wire insertion holes 281 is increased, and thus the high-voltage electric wires 201 are retained with certainty.

The electric wire insertion holes 281 are circular and each have a diameter substantially the same as that of each high-voltage electric wire 201. The ribs 288, which are on the inner surfaces of the electric wire insertion holes 281, extend in the circumferential direction, and protrude toward the center of each electric wire insertion hole 281.

Thus, the outer 41 the high-voltage electric wires 201 inserted into the electric wire insertion holes 281 are pressed by the ribs 288 extending in the circumferential direction and protruding toward the centers of the electric wire insertion holes 281. The ribs 288 pressing the outer surfaces extend in the circumferential direction. Therefore, even if an external force acts on the high-voltage electric wires 201 in a direction in which the high-voltage electric wires 201 are pulled out, the pressing force of the ribs 288 acts against the external force in such a pulling direction efficiently.

The rubs 288 extend in the circumferential direction and also protrude toward the centers of the electric wire insertion holes 281. Therefore, moisture flowing on the outer surfaces of the high-voltage electric wires 201 is prevented from entering the inside of the harness-side connector 20 from the electric wire insertion holes 281.

The plurality of ribs 288 are provided at a predetermined interval in a direction in which the electric wire insertion holes 281 extend. Therefore, the plurality of ribs 288 provided at the predetermined interval in the height direction H press the outer surfaces of the high-voltage electric wires 201. Thus, the force of the ribs 288 against the external force acting on the high-voltage electric wires 201 in the pulling direction is increased. The plurality of ribs 288 are provided at the predetermined interval in the height direction H, and therefore, the capability of the ribs 288 of stopping the moisture flowing on the outer surfaces of the high-voltage electric wires 201 is improved.

The attachment retaining portion 283 and the securing-side retaining portion 282 are formed separately, and the securing bolts 284 are provided to assemble and secure the attachment retaining portion 283 and the securing-side retaining portion 282, formed separately, to each other. Therefore, the high-voltage electric wires 201 is easily disposed at the securing-side arcked grooves 281a provided in the securing-side retaining portion 282, and then the attachment retaining portion 283 is secured to the securing-side retaining portion 282 separately formed therefrom by the securing bolts 284. Thus, the high-voltage electric wires 201 inserted into the electric wire insertion holes 281 are retained easily and certainly.

The attachment retaining portion 283 and the securing-side retaining portion 282 assembled together are tightened by the securing bolts 284 to be secured to each other. Therefore, the attachment retaining portion 283 and the securing-side retaining portion 282 are secured in a predetermined securing state by adjusting the tightening force of the securing bolts 284.

The wire seal 26 is provided to be outserted over the portions, of the high-voltage electric wires 201, inserted into the harness insertion cylinder 221, and to seal a space between the harness insertion cylinder 221 and the high-voltage electric wires 201 at a position on the upward side Hu with respect to the electric wire retaining portion 28. Therefore, the space between the harness insertion cylinder 221 and the high-voltage electric wires 201 is sealed on the upward side Hu with respect to the electric wire retaining portion 28. In addition, the wire seal 26 is disposed on the upward side Hu with respect to the electric wire retaining portion 28, and therefore, the wire seal 26 is prevented by the electric wire retaining portion 28 from being pulled off inadvertently.

Two high-voltage electric wires 201 are provided, and the electric wire retaining portion 28 includes two electric wire insertion holes 281 in accordance with the number of the high-voltage electric wires 201. Therefore, the high-voltage electric wires 201 are inserted into the two electric wire insertion holes 281 respectively, and are secured with certainty.

The retaining portion main body 222 and the shell main body 232 are provided with the connector securing portion 233, which secures the female inner housing 22 and the housing shell 23 to the device-side connector 10 including the device-side terminals 12, with which the harness-side terminals 21 are connected.

Therefore, the harness-side connector 20 and the device-side connector 10 are connected with each other firmly. Thus, the harness-side terminals 21 disposed in the female inner housing 22 and the device-side terminals 12 disposed in the device-side connector 10 are connected with each other stably.

The harness-side connector 20 includes the housing shell 23 and the female inner housing 22 disposed in the housing shell 23. The housing shell 23 includes the shell main body 232 and the harness insertion outer cylinder 231, and the female inner housing 22 includes the retaining portion main body 222 and the harness insertion cylinder 221.

Therefore, the retaining portion main body 222 of the female inner housing 22 is disposed in the shell main body 232 of the housing shell 23, and the harness insertion cylinder 221 of the female inner housing 22 is disposed in the harness insertion outer cylinder 231 of the housing shell 23.

The high-voltage electric wires 201 are inserted from the harness insertion cylinder 221 of the female inner housing 22, and the harness-side terminals 21 provided at the tips of the high-voltage electric wires 201 are disposed in the retaining portion main body 222 of the female inner housing 22.

The device-side connector 10 includes the device-side terminals 12 connected with the harness-side terminals 21. In the state where the device-side connector 10 and the harness-side connector 20 are connected with each other, the retaining portion main body 222 is fitted to the male housing 15 of the device-side connector 10. The housing seal 24 is provided between the retaining portion main body 222 and the male housing 15.

Therefore, the retaining portion main body 222 is fitted to the male housing 15 are connected with each other stably with no rattling. The housing seal 24 is provided between the male housing 15 in the device-side connector 10 and the retaining portion main body 222 fitted thereto. Therefore, the portion where the male housing 15 and the retaining portion main body 222 are filled to each other is protected against entrance of moisture.

The electric wire retaining portion 28 is provided on the harness insertion outer cylinder 231 of the housing shell 23. The harness insertion cylinder 221 of the female inner housing 22 is located on the upward side Hu with respect to the electric wire retaining portion 28 in the harness insertion outer cylinder 231 of the housing shell 23. Therefore, the electric wire retaining portion 28 including the attachment retaining portion 283 and the securing-side retaining portion 282 assembled together in the housing shell 23 retains the high-voltage electric wires 201 with certainty.

The attachment retaining portion 283 is integrally formed with the cover 237 covering the opening 236 of the housing shell 23. The attachment retaining portion 283 and the securing-side retaining portion 282 are assembled together and are secured in this state by the securing bolts 284. Thus, the harness insertion outer cylinder 231 is formed.

A part on the downward side Hd of the harness insertion cylinder 221 of the female inner housing 22 is disposed in a portion, corresponding to the opening 236, in the harness insertion outer cylinder 231 of the housing shell 23. The harness insertion outer cylinder 231 is integrally formed with the securing-side retaining portion 282. Therefore, the attachment retaining portion 283 integral with the cover 237 is assembled with the securing-side retaining portion 282, and thus the harness insertion cylinder 221 of the female inner housing 22 is sandwiched and thus held between the harness insertion outer cylinder 231 of the housing shell 23 and the cover 237.

The housing shell 23 is formed of an electrically conductive metal material. Therefore, the harness-side connector 20 including the housing shell 23 has a shielding double structure.

The shell seal 27 is provided to seal the space between the harness insertion cylinder 221 of the female inner housing 22 and the harness insertion outer cylinder 231 of the housing shell 23. Therefore, foreign objects are prevented from entering the harness-side connector 20 through a space between the harness insertion cylinder 221 of the female inner housing 22 and the harness insertion outer cylinder 231 of the housing shell 23.

The electric wire retaining portion 28 is provided at the end on the downward side Hd of the harness insertion outer cylinder 231 of the housing shell 23. Therefore, the shell seal 27 is prevented being from pulled off inadvertently.

The harness-side terminal according to the present invention corresponds to the harness-side terminal 21 in the above-described embodiment, and in a similar manner,
the electric wire corresponds to the high-voltage electric wire 201,
the housing corresponds to the female inner housing 22 and the housing shell 23,
the connector corresponds to the harness-side connector 20,
the housing main body corresponds to the retaining portion main body 222 and the shell main body 232,
the electric wire insertion portion corresponds to the harness insertion outer cylinder 231,
the electric wire retaining portion corresponds to the electric wire retaining portion 28,
the electric wire insertion hole corresponds to the electric wire insertion hole 281,
the securing-side retaining portion corresponds to the securing-side retaining portion 282,
the attachment retaining portion corresponds to the attachment retaining portion 283,
the pressing portion corresponds to the rib 288,
the counterpart securing portion corresponds to the connector securing portion 233,
the securing portion and the tightening member correspond to the securing bolt 284,
the electric wire seal corresponds to the wire seal 26,
the outer shell corresponds to the housing shell 23,
the inner housing corresponds to the female inner housing 22,
the outer shell main body corresponds to the shell main body 233,
the outer electric wire insertion portion corresponds to the harness insertion outer cylinder 231,
the inner housing main body corresponds to the retaining portion main body 222,
the inner electric wire insertion portion corresponds to the harness insertion cylinder 221,
the housing seal corresponds to the shell seal 24,
the electric wire insertion portion seal corresponds to the shell seal 27, and
the connector connection structure corresponds to the connector connection structure 1. However, the present invention is not limited to the above-described embodiment, and may be applied based on the technological idea defined by the claims and may be carried out in many embodiments.

For example, in the above-described embodiment, the generally semi-circular securing-side arcked grooves 281a are provided in the securing-side retaining portion 282, and the generally semi-circular attachment-side arcked grooves 281b are provided in the attachment retaining portion 283. The securing-side retaining portion 282 and the attachment retaining portion 283 are assembled together to form the generally circular electric wire insertion holes 281. Alternatively, generally U-shaped securing-side arcked grooves 281a as seen in the height direction H may be provided in the securing-side retaining portion 282, and the openings of the generally U-shaped securing-side arcked grooves 281a may be closed by the attachment retaining portion 283.

The wire seal 26 outserted over the high-voltage electric wires 201 and disposed in the harness insertion cylinder 221 may be pressed by the electric wire retaining portion 28 provided at the end on the downward side Hd of the harness insertion outer cylinder 231. In this manner, a pre-stress may act on the wire seal 26, and the sealing capability of the wire seal 26 may be improved.

The electric wire retaining portion 28 has two electric wire insertion holes 281 in accordance with the number (two) of the high-voltage electric wires 201. Alternatively, for example, the two electric wire insertion holes 281 may be disposed at a predetermined interval in the width direction W, and may be in communication with each other via a slit extending in the width direction W. The wire harness 200 may include one high-voltage electric wire 201, or three or more high-voltage electric wires 201.

The electric wire retaining portion 28 includes the securing-side retaining portion 282 and the attachment retaining portion 283, which are formed separately from each other. Alternatively, the two groups of securing-side arcked grooves 281a of the securing-side retaining portion 282 may be respectively assembled with different attachment retaining portions 283 each including the attachment-side arcked grooves 281b.

In the above description, the securing-side retaining portion 282 and the attachment retaining portion 283 are assembled together to form the electric wire retaining portion 28. The semi-elliptical cross-sections of the securing-side retaining portion 282 and the attachment retaining portion 283 appear to be obtained as a result of an elliptical shape being divided into two at the center in the depth direction D. Alternatively, the electric wire retaining portion 28 may be formed by assembling a securing-side retaining portion, located at the center in the width direction W, and attachment retaining portions located outer to the securing-side retaining portion. These portions are specifically obtained by dividing the electric wire retaining portion 28 along a line passing the center, in the width direction W, of each of the electric wire insertion holes 281 located side by side in the width direction. The securing-side retaining portion has securing-side arcked grooves on both sides thereof in the width direction W. The arcked grooves are each a part of the corresponding electric wire insertion hole 281. The two attachment retaining portions each have an attachment-side arcked groove.

In the harness-side connector 20 described above, the securing-side retaining portion 282 and the attachment retaining portion 283 in an assembled state are tightened to each other by the securing bolts 284. Alternatively, a bolt provided on one of the attachment retaining portion 283 and the securing-side retaining portion 282 may be inserted into the other of the attachment retaining portion 283 and the securing-side retaining portion 282, and the attachment retaining portion 283 and the securing-side retaining portion 282 may be tightened to each other by a nut provided separately. Still alternatively, a method that is not a tightening method, for example, a method using a wedge or the like may be used for the securing.

The attachment retaining portion 283 and the securing-side retaining portion 282 may be hinged to be integral together.

In this case, the attachment retaining portion 283, which is pivotable, is secured to the securing-side retaining portion 282 with an appropriate tightening force. The assembled state is secured in this manner.

In the above description, the ribs 288 extend in the circumferential direction on the inner surfaces of the electric wire insertion holes 281. Alternatively, the ribs 288 may extend in the height direction H. Instead of the ribs 288, protrusions other than the ribs, for example, semispherical protrusions may be scattered. The inner surfaces of the electric wire insertion holes 281 may have concaved and convexed portions.

In the above description, a portion on the downward side Hd of the harness insertion cylinder 221 is disposed in correspondence with the opening 236 in the harness insertion outer cylinder 231 of the housing shell 23, and the attachment retaining portion 283 is assembled with the securing-side retaining portion 282. In this manner, the harness insertion cylinder 221 is sandwiched and retained between the harness insertion outer cylinder 231 and the cover 237. Alternatively, the cover 237 and the harness insertion cylinder 221 may merely contact each other, or a space may be provided between the cover 237 and the harness insertion cylinder 221.

In the above description, the housing shell 23, in which the resin female inner housing 22 is to be disposed, is formed of a metal material in order to provide the shielding function. Alternatively, the female inner housing 22 to be disposed in the housing shell 23 may be formed of a metal material, and the housing shell 23 may be formed of a resin.

In the harness-side connector 20 described above, the retaining cover 60 including the attachment retaining portion 283, which is assembled with the securing-side retaining portion 282 and electrically conductively connected with the housing shell 23, is formed of an electrically conductive metal material. Alternatively, the retaining cover 60 may be formed of a resin. In this case, it is preferred that a metal layer is provided on an inner surface or an outer surface of the retaining cover 60 in order to be electrically conductively connected with the securing-side retaining portion 282.

In the above description, the housing shell 23 is formed by assembling the upper shell 31 and the lower shell 32 by the joining portion 33. The housing shell 23 may be of an integral type. Whether the housing shell 23 is of a divided type or an integral type, the position of the division in the case where the housing shell 23 is of a divided type, and the like may be appropriately selected in accordance with the designed shape and reasons regarding the assembly.

The harness insertion cylinder 221 and the harness insertion outer cylinder 231 do not need to be elliptical, but may be circular or polygonal or may have any appropriate cross-sectional shape such that the high-voltage electric wires 201 may be inserted thereinto.

The electric wire insertion holes 281 may be elliptical or polygonal, or a part thereof in the circumferential direction may be opened.

In the harness-side connector 20 described above, in the electric wire retaining portion 28 in the metal housing shell 23, the metal securing-side retaining portion 282 and the attachment retaining portion 283 of the metal retaining cover 60 sandwich and thus retain the high-voltage electric wires 201 disposed in the electric wire insertion holes 281. Alternatively, a resin retainer having the electric wire insertion holes 281 may be disposed between the high-voltage electric wires 201 and each of the metal securing-side retaining portion 282 and the attachment retaining portion 283.

With this configuration, the electric wire retaining portion 28, which includes the securing-side retaining portion 282 and the attachment retaining portion 283 assembled together and is included in the metal housing shell 23, retains the high-voltage electric wires 201 via the resin retainer. Such a connector is more lightweight than above-described harness-side connector 20, in which the electric wire retaining portion 28 is entirely metal.

### REFERENCE SIGNS LIST

1 . . . Connector connection structure
20 . . . Harness-side connector
21 . . . Harness-side terminal
22 . . . Female inner housing
23 . . . Housing shell
24 . . . Housing seal
26 . . . Wire seal
27 . . . Shell seal
28 . . . Electric wire retaining portion
201 . . . High-voltage electric wire
221 . . . Harness insertion cylinder
222 . . . Retaining portion main body
231 . . . Harness insertion outer cylinder
232 . . . Shell main body
233 . . . Connector securing portion
237 . . . Cover
281 . . . Electric wire insertion hole
282 . . . Securing-side retaining portion
283 . . . Attachment retaining portion
284 . . . Securing bolt
288 . . . Rib

1. A connector, comprising:
an electric wire having a harness-side terminal attached to a tip thereof; and
a housing having the harness-side terminal disposed therein,
wherein:
the housing includes:
a housing main body having the harness-side terminal disposed therein, and
an electric wire insertion portion in communication with the housing main body, the electric wire insertion portion having the electric wire inserted thereinto,
the electric wire insertion portion has an electric wire retaining portion provided thereon, the electric wire retaining portion retaining the electric wire,
the electric wire retaining portion has an electric wire insertion hole retaining the electric wire inserted thereinto, and
the electric wire retaining portion further includes:
a securing-side retaining portion provided on the housing main body and defining a part of the electric wire insertion hole, and
an attachment retaining portion defining another part of the electric wire insertion hole, the attachment retaining portion being attached to the securing-side retaining portion.

2. The connector according to claim 1, further comprising a pressing portion provided on at least a part of an inner surface defining the electric wire insertion hole, the pressing portion locally pressing at least a part of a portion, of an outer surface of the electric wire, that is inserted into the electric wire insertion hole.

3. The connector according to claim 2, wherein:
the electric wire insertion hole has a circular shape having a diameter substantially the same as that of the electric wire, and
the pressing portion has a rib shape that extends in a circumferential direction on an inner circumferential surface defining the electric wire insertion hole and protrudes toward a center of the electric wire insertion hole.

4. The connector according to claim 3, wherein a plurality of the pressing portions each having the rib shape are provided at a predetermined interval in a direction in which the electric wire insertion hole extends.

5. The connector according to claim 1, wherein:
the attachment retaining portion and the securing-side retaining portion are formed separately from each other, and
the connector includes a securing portion assembling and securing the attachment retaining portion and the securing-side retaining portion to each other.

6. The connector according to claim 5, wherein the securing portion is a tightening member tightening and securing the attachment retaining portion and the securing-side retaining portion to each other.

7. The connector according to claim 1, further comprising an electric wire seal outserted over a portion of the electric wire that is inserted into the electric wire insertion portion and sealing a space between the electric wire insertion portion and the electric wire on the side of the housing main body with respect to the electric wire retaining portion.

8. The connector according to claim 1, wherein:
a plurality of the electric wires are provided, and
a plurality of the electric wire insertion holes are provided in accordance with the number of the electric wires.

9. The connector according to claim 1, wherein the housing main body includes a counterpart securing portion securing the housing to a counterpart connector having a counterpart terminal connected with the harness-side terminal.

10. The connector according to claim 1, wherein:
the housing includes an outer shell and an inner housing disposed in the outer shell,
the outer shell includes an outer shell main body corresponding to the housing main body and an outer electric wire insertion portion corresponding to the electric wire insertion portion, and
the inner housing includes an inner housing main body corresponding to the housing main body and an inner electric wire insertion portion corresponding to the electric wire insertion portion.

11. The connector according to claim 10, wherein:
in a state where the inner housing main body is connected with the counterpart connector including the counterpart terminal connected with the harness-side terminal, the inner housing main body is fitted with a counterpart housing of the counterpart connector, and
a housing seal is disposed between the inner housing main body and the counterpart housing fitted with the inner housing main body.

12. The connector according to claim 11, wherein:
the outer shell includes the electric wire retaining portion, and
the inner electric wire insertion portion is disposed in the outer electric wire insertion portion on the side of the housing main body with respect to the electric wire retaining portion.

13. The connector according to claim 10, wherein:
the electric wire insertion portion is cylindrical,
the attachment retaining portion is provided on a part of the outer electric wire insertion portion, and
the attachment retaining portion and the securing-side retaining portion are secured to each other by the securing portion to form the electric wire insertion portion to be cylindrical.

14. The connector according to claim 13, wherein at least a part of the inner electric wire insertion portion is disposed in the outer electric wire insertion portion provided on the attachment retaining portion.

15. The connector according to claim 12, wherein the outer shell is formed of a metal material.

16. The connector according to claim 15, wherein a resin retainer having the electric wire insertion hole is provided between the electric wire retaining portion in the metal outer shell and the electric wire.

17. The connector according to claim 10, further comprising an electric wire insertion portion seal sealing a space between the inner electric wire insertion portion and the outer electric wire insertion portion.

18. A connector connection structure, comprising:
a connector including an electric wire having a harness-side terminal attached to a tip thereof and also including a housing: including the harness-side terminal disposed therein, and
a counterpart connector including a counterpart terminal connected with the harness-side terminal,
wherein:
the connector and the counterpart connector are connected with each other,
the housing includes:
a housing main body having the harness-side terminal disposed therein, and
an electric wire insertion portion in communication with the housing main body, the electric wire insertion portion having the electric wire inserted thereinto,
the electric wire insertion portion has an electric wire retaining portion provided thereon, the electric wire retaining portion retaining the electric wire,
the electric wire retaining portion has an electric wire insertion hole retaining the electric wire inserted thereinto, and
the electric wire retaining portion further includes:
a securing-side retaining portion provided on the housing main body and defining a part of an electric wire insertion hole, and
an attachment retaining portion defining another part of the electric wire insertion hole, the attachment retaining portion being attached to the securing-side retaining portion.

19. The connector connection structure according to claim 18, wherein the housing main body includes a counterpart securing portion securing the housing to the counterpart connector.

20. The connector connection structure according to claim 19, wherein:
the housing includes an outer shell and an inner housing disposed in the outer shell,
the outer shell includes an outer shell main body corresponding to the housing main body and an outer electric wire insertion portion corresponding to the electric wire insertion portion,
the inner housing includes an inner housing main body corresponding to the housing main body and an inner electric wire insertion portion corresponding to the electric wire insertion portion,
the inner housing main body is fitted with a counterpart housing of the counterpart connector, and
a housing seal is disposed between the inner housing main body and the counterpart housing fitted with the inner housing main body.
